(19) United States
(12) Patent Application Publication
(10) Pub. No.: US 2009/0265233 A1
(43) Pub. Date: Oct. 22, 2009

(54) METHODS FOR PROVIDING INCENTIVES FOR USE OF ONLINE SERVICES

(75) Inventors: Mark Sendo, Ann Arbor, MI (US); Jonathan Leighton Brown, Ann Arbor, MI (US)

Correspondence Address: YOUNG BASILE, 3001 WEST BIG BEAVER ROAD, SUITE 624, TROY, MI, 48084, US

(73) Assignee: UrTurn.Com, LLC, Ann Arbor, MI (US)

(21) Appl. No.: 12/107,557

(22) Filed: Apr. 22, 2008

Related U.S. Application Data
(60) Provisional application No. 61/046,603, filed on Apr. 21, 2008.

(51) Int. Cl. G06Q 30/00

(52) U.S. Cl. 705/14

(57) ABSTRACT

A system and method permits a primary online service to award and redeem incentive points to users of a social networking or other third-party site that operates independently of the primary online service. The primary online service publishes copies of a widget on the social networking site. The widget communicates with the social networking site through an API published by the operators of the social networking site. When user of the social networking site activates the widget, the primary website awards incentive points to the user based on the user's activities at the social networking site. These activities are tracked by the widget, which also displays to the user the balance of award points and advertising messages. The user can redeem points for goods, services or other consideration and can buy and sell points with other users.

### RELATED APPLICATIONS

This application claims the benefit of the filing date of: (a) Provisional Patent Application Ser. No. 60/052267 entitled “System and Method for Enabling Users to Earn Points/Vote/Manage and Share in Profits for Online Social Networking Website,” filed on Jul. 27, 2007, the disclosure of which is hereby incorporated by reference in its entirety; and (b) Provisional Patent Application Ser. No. 61/046603 entitled “Methods for Providing Incentives for Use of Online Services,” filed Apr. 21, 2008, the disclosure of which is hereby incorporated by reference in its entirety.

### FIELD OF THE INVENTION

The present invention relates to incentive programs generally and in particular incentive programs that measure use of online services.

### BACKGROUND

The Internet is a popular communications network that offers many types of sites, including social networking sites. Social networking sites permit users to interact with other users in an online community. Other popular sites include online auction sites, sites where users can download music, search portals and online commerce sites. Some of these sites permit third party developers to publish programs—sometimes called widgets—that interoperate with these sites through application program interfaces published by the site operator.

Many web sites generate income by selling adverting space that is displayed to users of the site. Other web sites generate income by transacting businesses with, such as selling goods or services. The operators of websites may provide various incentives to encourage traffic or transactions at their sites. For example, some website operators have offered to share advertising revenues with users to incentivize traffic. An airline may offer frequent flier points to customers who make reservations at the airline's website. Other sites award points for viewing advertising, providing demographic information, completing surveys or taking other actions that the point-awarder seeks to encourage.

### SUMMARY

In one embodiment, a method is disclosed for permitting a primary online service to award incentive points to users of a third-party site that operates independently of the primary online service. The method includes publishing copies of a computer program on the third-party site. The computer program collects usage information concerning the activities performed on the third-party site by users who add the computer program to their user accounts on the third-party site; and transmits the usage information to the primary online service. The method also includes awarding incentive points to the users based on the usage information received by the primary online service; and redeeming incentive points for consideration. The awarding of incentive points by the primary online service is substantially independent of the operation of the third-party site.

In other embodiments, a method is disclosed for permitting a primary online service to award incentive points to users of a plurality of independently operated third-party sites. The method includes distributing a computer program on each of the plurality of third-party sites. The computer program collects usage information concerning the activities performed on that third-party site by users who activate the computer program for use with their user accounts on that third-party site; and associates an identification code for each user who activates the computer program. The identification code is assigned by the primary online service. The computer program also transmits the usage information for each user and the user's identification code to the primary online service. The method further includes awarding points to each user based the usage information associated with that user's identification code, and tracking points awarded in an incentive point account associated with the user; providing a facility through the primary online service to permit users to exchange points for consideration; and displaying the balance of at least one user's incentive point account when the user accesses at least one of the social networks.

In other embodiments, a method is disclosed for permitting a primary online service to award incentive points to users of a third-party site that operates independently of the primary online service. The method includes collecting usage information concerning the activities performed on the third-party site by users who opt to receive incentive points; transmitting the usage information to the primary online service; awarding incentive points to the users based on the usage information, wherein the awarding of incentive points by the primary online service is substantially independent of the operation of the third-party site; displaying to at least one of the users an advertising message originating from the primary online service when the at least one user is conducting activities on the third party web site; providing a facility on the primary online service to permit at least one user to buy and sell incentive points to and from at least one other user; and redeeming the incentive points for consideration.

### BRIEF DESCRIPTION OF THE DRAWINGS

The description herein makes reference to the accompanying drawings wherein like reference numerals refer to like parts throughout the several views, and wherein:

FIG. 1 is block diagram of an online system in accordance with an embodiment of the invention.

FIG. 2 is a block diagram of an application program used in the system of FIG. 1.

FIGS. 3A and 3B are diagrammatic representation of screens displayed to a user of the system of FIG. 1 in a first mode operation.

FIG. 4 is diagrammatic representation of a screen displayed to a user of the system of FIG. 1 in a second mode of operation.

FIG. 5 is diagrammatic representation of a screen displayed to a user of the system of FIG. 1 in a third mode of operation.

FIG. 6 is flow chart illustrating a method of using the online system of FIG. 1.

FIG. 7 is a block diagram of the points transaction unit of system of FIG. 1.

FIG. 8 is block of an online system in accordance with an alternative embodiment of the invention.

### DETAILED DESCRIPTION

Systems and methods are disclosed for permitting a primary online service to award incentive points to users of a third-party site that operates independently of the primary online service. In the disclosed embodiments, the third-party site includes a social networking site such as Facebook, a service operated by Facebook, Inc. of Palo Alto, Calif. However, the methods disclosed herein can be practiced with other types of third-party sites, including online auctions, e-tailing, online financial services sites, blogs, news sites, sites for downloading music, video and other content such as iTunes and YouTube, search engines such as Google, portals such as Yahoo, Internet telephony services such as Skype, and sites that offer email and other communications service such as hotmail.com, and other types of site not yet devised.

The primary online service can be a service dedicated solely to awarding points or can include additional features and functionalities. For example, the primary online service could be a social network site that also awards incentive points in accordance with the embodiments disclosed herein.

In one embodiment, the computer program includes instructions that cause one or more computers to collect usage information concerning the activities performed on the third-party site by users who add the computer program to their user accounts on the third-party site; and to transmit the usage information to the primary online service. The usage information can be obtained by interrogating the third-party site through a query language, API or other facility provided by the third-party site. It can include information such as how long the user is logged on, numbers of transactions or postings made by the user, posting content, sending and receiving messages, voting, installing tools, commenting on other users' content, referring new users, and other activities enabled by the third-party site. To encourage adoption of the computer program, the primary online service can award incentive points to who distribute the computer program to other users of the third-party site.

In some embodiments, the primary online service operates independently from the third-party site. That is, the primary online service is not perceived by the end users as being part of the same site or business enterprise as the third-party sites. Independence does not preclude cooperation or information sharing, such as having the third-party site provide application program interfaces. Also, there can be varying degrees of independence. In one embodiment, the primary online service publishes its widget on a social network without any express sanctioning or payment by the social network. It can even be the case that the operators of the social network are not aware of the operation of the widget or fact that the primary online service is awarding incentive points to users of the social network. In other embodiments, the social network can actively participate with and compensate the primary online service for making incentive points available to users of the third-party site.

The computer program can transmit the usage information to the primary online service through the hypertext transfer protocol or other suitable protocols, and these transmittals can be secured through encryption if desired. The transmissions can occur substantially in real time, or if desired usage data can be accumulated at the third-party site or user's computer and transmitted in batch periodically, such as when the user logs off the third-party site.

The primary online service receives and accumulates usage data for each user. To facilitate the tracking of users, a user can register with the primary online service and be assigned an identification code such as a number, alpha-numeric designation or user name. This code can be provided to the computer program so that when the computer program transmits usage information, that usage information can be associated with the use by the identification code. As explained below, this arrangement facilities the practice of the disclosed embodiments when across multiple third-party sites. The registration process (and assignment of the identification code) can take place when the user initially activates the computer program through the third-party site. Alternatively, the user can register directly with the primary online service and be given the identification code and/or other token to be used when subsequently activating the computer program through the third-party site.

Instantiations of the computer code can also be given unique identification codes and these can be associated with the corresponding user's identification code to provide an additional level of control and security in assuring that usage data is authentic.

Based on each user's usage data, the primary online service can award incentive points. The primary online service can establish an award policy to grant a predetermined number of points for specific activity. For example, the primary online service can award 80 points to a user for posting a picture and 20 points to a user for commenting on a picture. The policy can be designed to reward more points those tasks that require a longer time to perform (this increasing the amount of time spent viewing advertising displayed by the computer program.

To give the incentive points value, the primary online service provider can permit users to redeem the incentive points for consideration. The consideration can include goods such as consumer electronics or services such as airline flights. The online service provider can permit redemption directly or can allow users to redeem incentive points through agents or others who have contracted with the primary online service. In some embodiments, the consideration is redeemable for a number of incentive points that is set by an auction among users seeking the consideration. In other embodiments, consideration is a chance to receive at least one of a good, service, software and content. In other embodiments, the primary online service provider allows users to make wagers using incentive points, such as on games of chance or other events.

The awarding of incentive points by the primary online service can be substantially independent of the operation of the third-party site. It that it is not necessary that the providers of the third-party sites be involved in awarding or redeeming incentive points or in paying the primary online service provider for awarding points. For example, it is possible for the primary service provider to operate independently of the third-party sites in awarding the points.

The primary online service can maintain an incentive point account for each user to track the balance of that user's incentive points. The account can be associated with the user's identification code. The primary online service can transmit account information to the user, including the user's incentive point account. This information can be displayed when the user accesses the third-party site. For example, the primary online service can transmit the user's balance to the computer program in response to a polling type request periodically issued to the primary online service provider when the user is accessing a third-party site. The balance information can be displayed to the user.

Through the computer program, the user can designate as “friends” other users of the third-party site who have activated the computer program. The primary online service can transmit to user's balance and other account information to the friends. Thus, groups of users can see each other's point totals. This may foster friendly competition or facilitate exchange of points as described below.

The primary online service can also transmit advertising messages to the user, including the user's incentive point account. These advertising messages can be displayed when the user accesses the third-party site. Additional advertising message can be displayed when the user visits the primary online service provider to obtain account information or exchange or redeem points, as describe below. In some embodiments, the primary online service can gather demographic information about each user such as during the registration process. The primary online service can use this information to target advertising messages to appropriate users. In some embodiments, the computer program is configured to track usage information (and thus provide a basis to award incentive points) only when the advertising message is displayed.

In some embodiments, the primary online service allows user to redeem incentive points for consideration that is available in limited quantities on a first-come-first serve-basis. Alternatively, the consideration is available for a limited time period. Alternatively, the number of points required for redemption can be scheduled to increase in the future. Alternatively, the incentive points can be effective for a limited time period. These conditions may stimulate demand for incentive points among users who have accumulated substantial points but are short of the number of points required to procure a desired consideration. For example, if a popular audio player is available in exchange for 1000 incentive points, and a particular user has accumulated only b750 points, the user's urgency or demand for the additional required points may be stoked if the desired audio player is only available for a limited time, or if the number of points required for the player is scheduled to increase or if the user's accumulated points are only valid for a limited time.

Under these conditions, the user has a limited time to gather the necessary points and may be interested in buying additional points. At the same time, some users may accumulate only a few points and may not be able to or interested in accumulating the points necessary to redeem for consideration. These users may be interested in selling their points. To facilitate the exchange of points by users, the primary online service can provide a marketplace for the buying and selling of points among users or with the online marketplace itself. The marketplace can also permit points to be sold at auction. There can be combinations of trading and auctioning points. For example, a user can acquire points through the marketplace and then use those points in an auction of a good or service.

In an alternative embodiment, the systems and methods disclosed herein can be used with multiple third-party sites, including sites that may compete. In this alternative embodiment, the primary online service distributes a computer program on each of a plurality third-party sites. Different third-party sites may require very different programs to implement the embodiments described herein, depending on the platform that those programs operate on. The term “computer program” as used herein encompasses these different programs.

When the computer program is distributed to a third-party site, users of the site can activate the computer program for use with the third-party site. Typically, access to the third-party site will be through user accounts, and the activation of the computer program can also be through the users' accounts. Once activated, the computer program can reside at the servers of the third-party site or on the local computers of the end users, or may distributed across both platforms.

As described above, the computer program once activated, collects usage information concerning the activities performed on a third-party site by users who have activated the computer program for use with their user accounts on that third-party site. The collection of information can be permission based, with the user expressly consenting to the collection when he or she activates the computer program. The computer program can associate an identification code for each user who activates the computer program. As described in the preceding embodiments, the identification code can be assigned to the user by the primary online service. The computer program transmits the usage information for each user and the user's identification code to the primary online service.

The primary online service can award points to each user based the usage information associated with that user or the user's identification code. The primary online service can tracking points awarded to each user's in an incentive point account associated with the user or the user's identification code. The primary online service can also provide a facility through which users can exchange points for consideration, including, for example, goods and services.

By tracking users' assigned identification codes, the primary online service can track usage of a particular user across a number of third-party sites and can accumulate award points based that usage. Thus, systems and methods described herein are not limited to use with just one third-party site but can follow the user to multiple third-party sites, even third-party sites that compete, operate independently or otherwise do not wish to collaborate on facilities to track usage and award incentive points.

The primary online service can display the balance of a user's incentive point account when the user accesses at least one of the social networks through a user account for which the user has activated the computer program. The primary online service can also display advertising messages originating from primary online service. By “originating” it is mean directly or indirectly transmitted by the primary online service or its agents. For example, the primary online service may sell advertising space through a network of distributors or affiliates, and in that case the advertising messages would be considered to “originate” from the primary online service provider even if the message did not pass through the primary online service provider's servers.

In some embodiments, a first user can designate as “friends” other users registered with the primary online service providers, even if those friends are not all using the same third-party site or sites. The primary online service provider can display the number of points awarded to the first user (or other account information or other information pertaining to the first user) to that user's friends, even as the user and his or her friends are using the same or different third party sties.

In some embodiments, the primary online service provider can also display to at least one of the friends, information about the first user's activities at a first third-party site while the friend accesses a different third-party site. Thus, if the first user is on Myspace and a friend is on Facebook.com, the online service provider can display to the friend information such as the fact that the first user has posted a picture on MySpace.com. In addition to account and activity information, the primary online service can also relay messages, including code and content, between the first user and the friend. The friend in turn can designate the first user as a “friend” and in this manner the exchange of information can be two-way. In this manner, the systems and methods bridge social networking across multiple social networks and other third-party sites, even third-party sites that compete, operate independently or otherwise do not wish to exchange real-time user information and messages.

The primary online service can reside on a single server or group of servers or can be distributed across multiple machines in multiple physical or logical addresses. Portions of the operations of the primary online service can also be subcontracted or outsourced.

In other embodiments, the primary online service provider can publish an application program interface to permit unrelated sites and other third-party application providers to make access to the primary online service available through those third-party sites and applications. In other words, the point granting and award systems and methods described herein can be independently bolted-on to third-party offerings so that users of those third-party offerings can earn points to be used in the electronic marketplace of the primary online service provider.

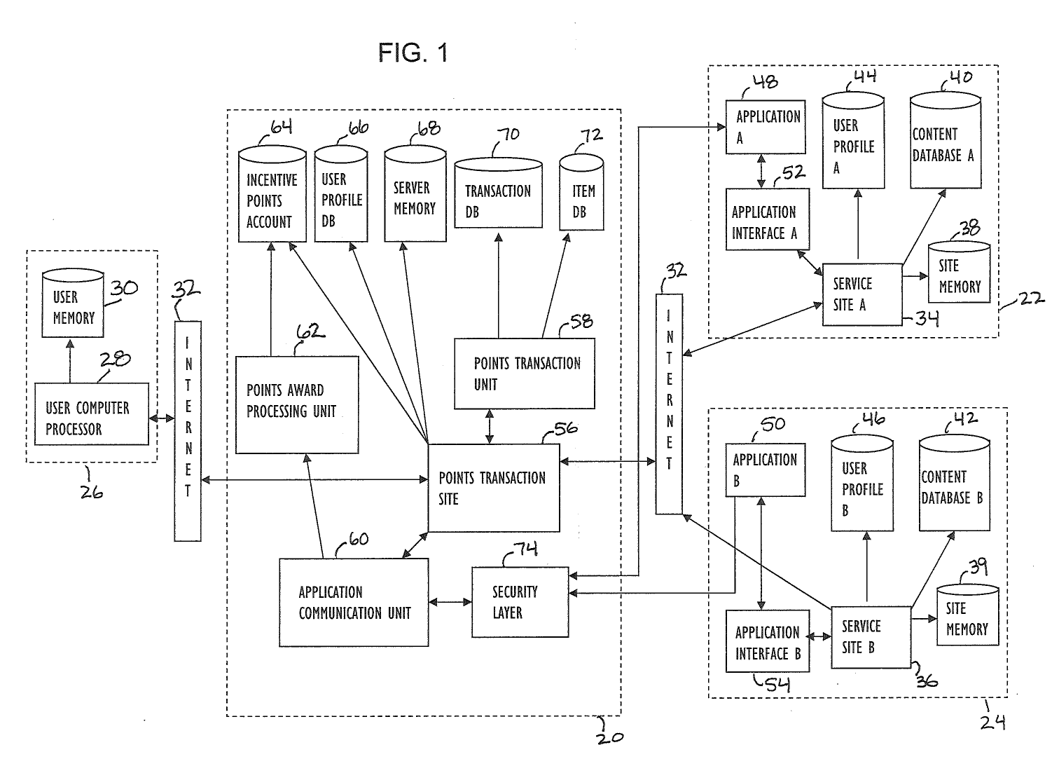

The foregoing and other systems and methods are no described in further detail with respect to the accompanying drawings. Referring to FIG. 1, the point awards system includes a primary online service 20, one or more third-party sites, 22, 24, which for purposes of this illustration are social networking sites but which can be other types of online services and facilities, and the user computer 26. The user computer 26 includes a user computer processor 28 and a memory 30; the user computer 26 is connected to the primary online service 20 and the third-party sites 22, 24 through the internet 32 primary online service 20 is also connected to the third-party servers 34, 36 through the internet 32.

For the purpose of illustration, the configurations of third-party sites 22, 24 are shown as comparable. In practice, the can be different. Third-party sites 22, 24 can have third-party servers 34, 36, respectively, which typically have interlinked computing platforms with access to site memory 38, 39 hat function like locally-available software in the perception of the user. Furthermore, the third-party sites 22, 24, 36 can include a social element where users generate and distribute contents, often with freedom to share and reuse. Typically the third-party servers 34, 36 are coupled to databases 40-46 that can be modified by users through different activities; such modifications to the contents usually includes adding, changing or deleting information or associating metadates with the existing information contained in the databases; other modifications can include ways to display the content or the content and the external aspect simultaneously. The databases 40-46 typically contain a content database 40, 42, and a user profile database 44, 46.

To gain access to the third-party sites 22, 24, the primary online service disseminates computer programs 48, 50 onto the third-party sites 22, 24. These programs, which are also referred to herein as applications 48, 50 can be directly published by the primary online service provider or its agents or can be “released into the wild” and copied by third party user's and distributors, in come cases acting independently of the primary online service provider. The terms “publish” and “distribute” and “disseminate” as used herein in regard each are intended to contemplate all forms of distribution, publication or other dissemination, whether direct or indirect or intentionally or by means of third party actors outside of the control of the primary online service.

Applications 48, 50 can access the third-party servers 34, 36 via the application interfaces 52, 54. An example of an application 48, 50 is an object code supplied by the primary online service 20 and is embedded in or linked with object code of the third-party servers 34, 36; the application 48, 50 can also be a code object supplied by the primary online service 20 and is embedded in or linked with the source code or the object code of the third-party servers 34, 36; the application 48, 50 can also be a widget. As shown in FIG. 1, the primary online service 20 includes a points transaction site 56, a points transaction unit 58, an application communication unit 60, and a points award processing unit 62. The primary online service 20 can access an incentive point account 64, a user profile database 66, server memory 68; the points award processing unit 62 can access to the incentive point account 64; and the points transaction unit 58 can access a transaction database 70, and an item database 72. The application communication unit 60 is further connected to a security layer 74, and the security layer 74 is connected to application 48, and application 50 via a secured connection. Persons skilled in the art will readily understand that the number of application the application communication unit 60 can connect to via the security layer 74 is not limited to the applications 48, 50 shown in FIG. 1.

As shown in FIG. 1, the user can independently access the points transaction site 56, and the third party service sites 34, 36 with the user computer 26 via the internet 32. This can be done through a web browser, for example Internet Explorer, Firefox, Opera, Safari, Netscape, Mozilla, and others; this can also be done through a terminal server established with the points transaction site 56 or the third party service sites 34, 36; this can also be done through any generic interface where the user can access data to which the points transaction site 56 and the third party service sites 34, 36 have access.

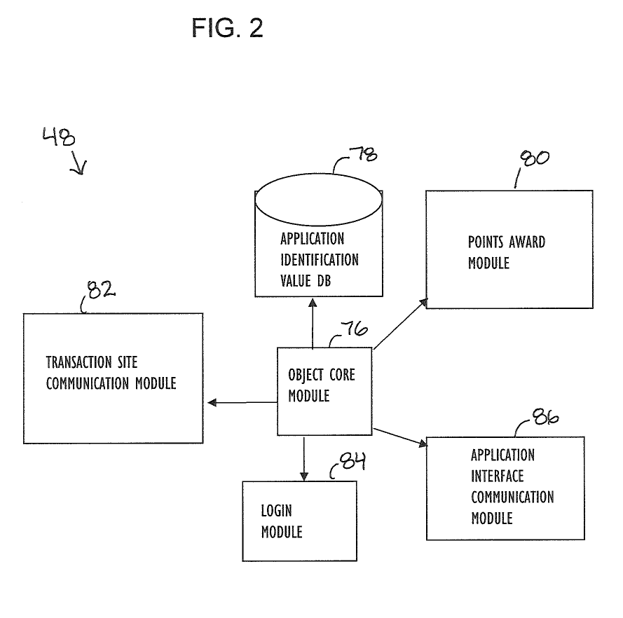

Referring to FIGS. 1 and 2, application 48 is shown in more detail. For purposes of this illustration, application 50 has the same configuration. Application 48 includes a object core module 76, an application identification value database 78, a points award module 80, a transaction site communication module 82, a login module 84, and an application interface communication module 86. The application identification value database 78, points award module 80, transaction site communication module 82, login module 84 and application interface communication module 86 are individually connected to the object core module 76, wherein the object core module is acting as I/O hub directing the data flow among the communicating modules. Other modules with specific function or a combination of functions can be added to the application 48, for example modules that can communicate with the user's computer 26, modules that facilitates online commerce, modules that facilitates email exchanges, modules that facilitates content exchanges, and modules that facilitates data exchanges.

The transaction site communication module 82 is configured to establish a secure communication connection with the application communication unit 60 through the security later 74, wherein the application 48 communication with the primary online service 20 is protected by standard restrictions on the source of the communication by the internet addresses, although other methods of providing a secure connection such as public key or shared secret encryption can be used to secure the communication between the application communication unit 60 and the transaction site communication module 82. The login module 84 is used to provide authentication of the user with the primary online service 20, wherein the login module will take user input in arguments USERNAME and PASSWORD and access the user profile database 66 of the primary online service 20 via the transaction site communication module 82 with the GET or POST function. If the inputted USERNAME and PASSWORD matches the same USERNAME and PASSWORD found in the user profile database 66, then the user has successfully linked to the primary online service 20; if the inputted USERNAME and PASSWORD does not match the same USERNAME and PASSWORD found in any user profile in the user profile database 66, the login has failed and the user is not connected to the primary online service 20.

Transaction site communication module 82 can also be used to query the primary online service 20. For example, the transaction site communication module 82 can get the current user points by using the USER ID of the user and query the incentive point account 64 of the primary online service 20 to obtain current points balance for the user; if the USER ID is invalid, the primary online service 20 will return a fault and the user is then notified. The transaction site communication module 82 can also query other user information stored on the primary online service 20. One example is using the transaction site communication module 82 to query the recent activities of the user; this can be accomplished by query the primary online service 20 using arguments USER ID and NUMBER OF RECORDS TO RETRIEVE, so that the primary online service 20 returns a list of records with timestamp, wherein the records includes a social network name (or indicate that it's the transaction on the points transaction unit 58), account point adjustment positive or negative), and a human-readable description (if available).

The list of records can be sorted by timestamp, or in ascending or descending order. The type of information transaction site communication module 82 is able to query is not limited to the type of information explained thus far, other information can also be queried. For example, the transaction site commutation module 82 can query the statistics of the points transaction unit 58 of the primary online service 20; the statistics can include prior day's closing average value of points in $s, the latest transaction value of points in $s, total volume transacted in points and dollars today, yesterday, last month, and ever, total volume redeemed in points and dollars (MSRP) today, yesterday, last month, ever, users recent transaction and latest and best deal items.

Points award module 80 is used to collect user's usage information and award points for user's usage. Usage information can be posting a message, logging in, confirming a request, posting a picture, voting on a topic, sending a message, receiving a message, posting in shared links, adding a widget, and others. Usage information can be collected by the points award module 80 by identifying actions performed by the user via the application interface communication module 86 and the application interface 52, 54, Action performed by the user on the third-party servers 34, 36 is identified and is associated with an ACTION ID; in addition, the points award module 80 will query the third-party servers 34, 36 for its SITE ID. One example of the communication protocol between the application communication module 86 and the application interface 52, 54 can is Facebook API or Open Social API; other APIs can also depending on the API of the third party service server 20, 22.

After the points award module 80 receives the information from the third-party servers 34, 36, the points award module 80 will then contact the points award processing unit 62 of primary online service 20 via the transaction site communication module 82 using arguments USER ID, SITE ID, ACTION ID, STICKINESS MULTIPLIER, and DESCRIPTION STRING. The points award processing unit 62 can then determine if points should be awarded according to the business logic for the third-party servers 34, 36 and the actions user performed on the third-party servers 34, 36; after the points award processing unit 62 determined that points can be awarded, the points award processing unit 62 will then store the points in the incentive point account 64 and the points award processing unit 62 will also return the number of points awarded back to the points award module 80 via the application communication unit 60 and the transaction site communication module 82 through the security layer 74 so that the number of points awarded can be displayed to the user.

The transaction site communication module 82 can also provide registration function, wherein the transaction site communication module 82 is able to register and unregister the third-party sites 22, 24 with the primary online service 20. The primary online service 20 maintains a list of third-party sites 22, 24 associated with the user registered in the user profile database 66. This can be accomplished by accessing the primary online service 20 via the transaction site communication module using arguments USER ID and SITE ID, wherein the SITE ID can be add or deleted from the user profile database 66.

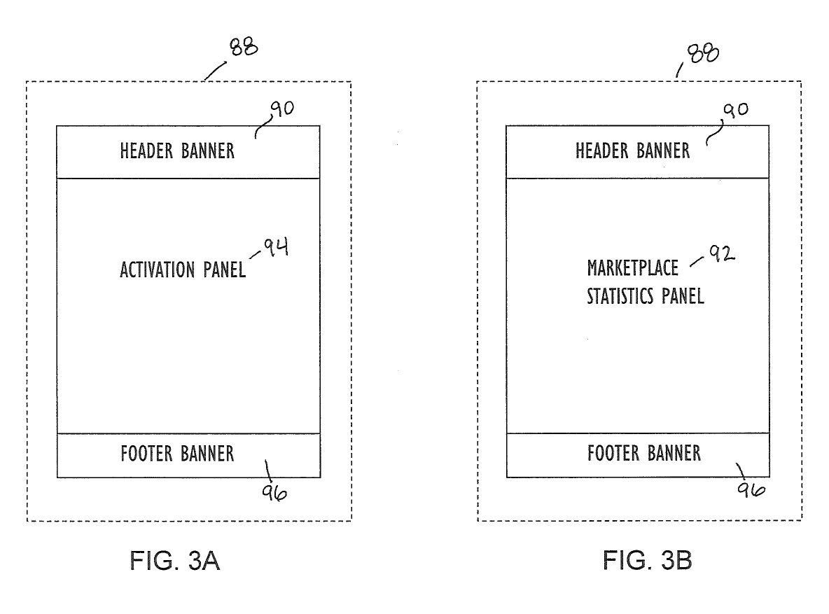

Referring to FIGS. 3A and 3B, applications 48, 50 can generate a display such as object tile 88 object tile 88 comprising a header banner 90, a transaction statistics panel 92 (FIG. 3B), an activation panel 94 (FIG. 3A) and a footer banner. If the user has not logged in or has not registered the application 48, 50 with the points transaction site 56, the activation panel 94 is displayed on the user computer 26 instead of the transaction statistics panel 92. One example of the header banner 90 can be the logo of the primary online service 20. The header banner 90 can also be configured to display advertising and other data stream. The transaction statistics panel 92 can be used to display transactions stored in the transaction database 70 of the primary online service 20. Information displayed in the transaction statistics panel 92 can includes Points Balance, Latest Friends Points, and Last Point Price. If the user is not logged in or the application 48, 50 is not registered with the points transaction site 56, an activation message is displayed in the activation display panel 94.

The activation message can be used to encourage the user to either login or to register the application 48, 50 with the points transaction site 56. The footer banner 96 can be used to display limited market statistics; the statistics can include prior day's closing average value of points in $s, the latest transaction value of points in $s, total volume transacted in points and dollars today, yesterday, last month, and ever, total volume redeemed in points and dollars (MSRP) today, yesterday, last month, ever, users recent transaction and latest and best deal items. The object tile 90 is typically fully integrated as part of the user-display generated by third-party servers 34, 36. For example, the object tile 90 can occupy a small portion of the total display on the user computer 26, wherein the object tile 90 and other display elements of the third-party servers 34, 36 can be displayed together.

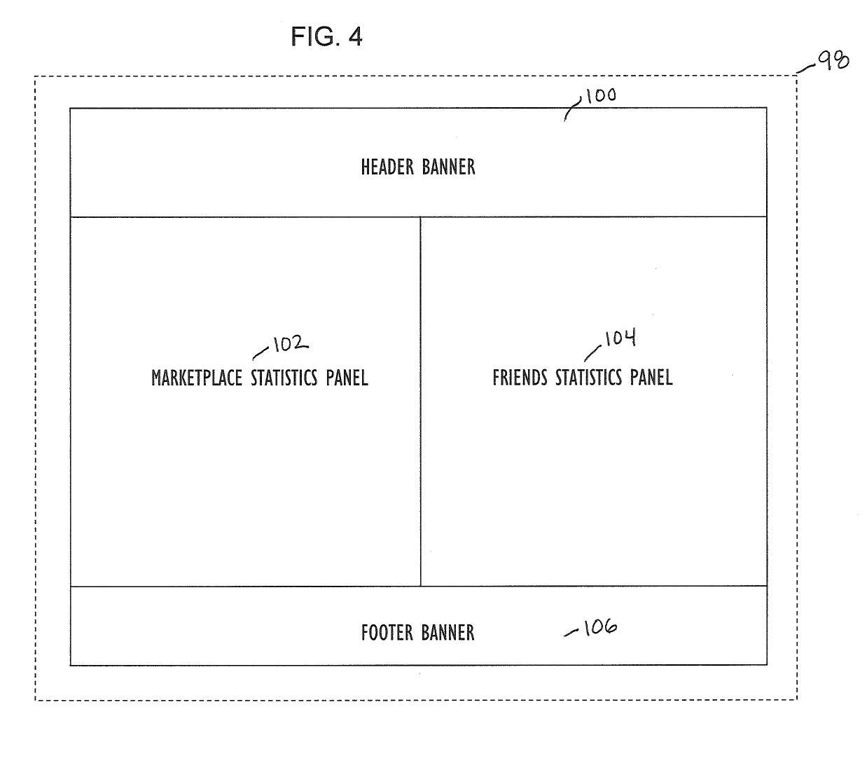

Referring to FIG. 4, the application 48, 50 can also display as object profile 98, as shown in FIG. 4, includes a header banner 100, a transaction statistics panel 102, a friends statistics panel 104, and footer banner 106. Referring to FIG. 4 an example of the header banner 100 can be the logo of the points transaction site 56; the header banner 100 can also be configured to display advertising and other data stream. The transaction statistics panel 102 can be used to display transactions stored in the transaction database 70 of the primary online service 20. Information displayed in the transaction statistics panel 102 can includes Points Balance, Latest Friends Points, and Last Point Price.

The friends statistics panel 104 can be used to display information related to the user's friends; an example of the friends statistics includes the name of the friend and their total accumulated points; other examples of the friends statistics can include the transaction data of the friends stored in the transaction database 70 of the primary online service 20. The footer banner 106 can be used to display an item redemption list, wherein the item redemption list can include a display of a random listing of at least one redeemable item for a predetermined amount of time; the display can refresh after a predetermined amount of time to display another random listing of at least one redeemable item. The object profile 98 is typically less integrated as a part of the display generated by third-party servers 34, 36 than the object tile 88 (FIG. 3). For example, the object profile 98 can occupy a larger portion of the total display with respect to the total display area on the user computer 26 than that of the object tile 88 (FIG. 3), wherein the object profile 98 and other display elements of the third-party servers 34, 36 can be displayed together.

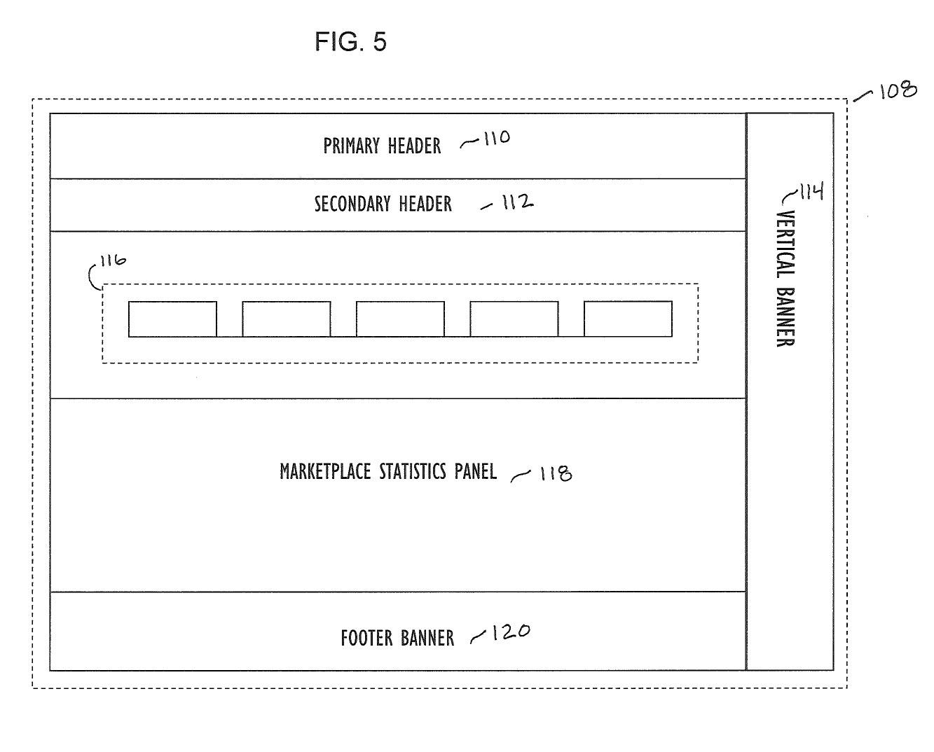

The application 48, 50 can also be displayed as an object canvas 108, as shown in FIG. 5, includes a primary header banner 110, a secondary header banner 112, a vertical banner 114, a tab group 116, a transaction statistics panel 118, and a footer banner 120. Referring to FIG. 5 an example of the primary and secondary header banner 110, 112 can be the logo of the points transaction site 56; the primary and secondary header banner 110, 112 can also be configured to display advertising and other data streams. The transaction statistics panel 118 can be used to display transactions stored in the transaction database 70 of the primary online service 20. Information displayed in the transaction statistics panel 118 can includes Points Balance, Latest Friends Points, and Last Point Price. The tab group 60 can be configured to include a plurality of tabs; for example, the tab group 60 can include a private messaging tab, a redeemable item tab, a shopping tab, an email tab, an overview tab, a friends tab, a transaction tab, a setting tab, a help tab, and others. The footer banner 120 can be used to display an item redemption list, wherein the item redemption list can include a display of a random listing of at least one redeemable item for a predetermined amount of time; the display can refresh after a predetermined amount of time to display another random listing of at least one redeemable item. The object canvas 108 is typically not integrated with the third-party servers 34, 36, wherein the object canvas 108 can occupy the same area of display on user computer 26 as the third-party servers 34, 36.

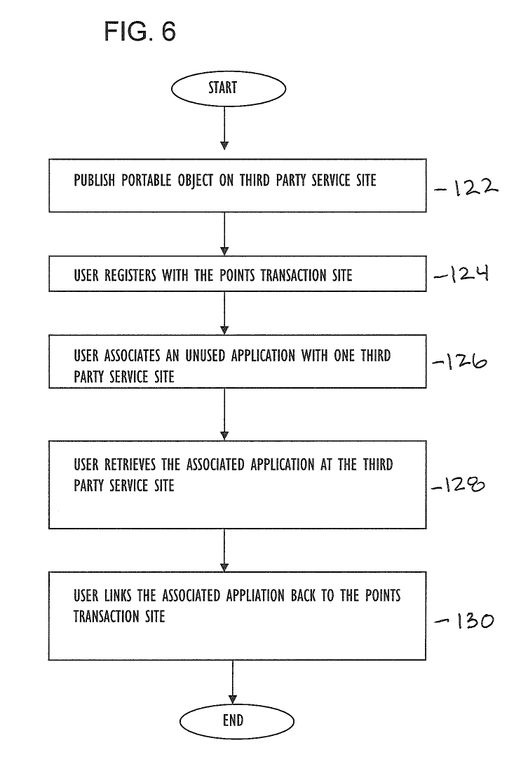

Referring to FIGS. 1, 2 and 6, the user can deploy the application 48, 50 at the third-party sites 22, 24 by perform the following steps. At step 122, the operator of the primary online service 20 posts or otherwise publishes copies of applications 48, 50 on third-party sites 22, 24, respectively. The posting of the application 48, 50 can be done by the users of the third-party sites 22, 24; the posting of the application 48, 50 can be done by anyone with writing access to the content database 40, 42 of the third-party sites 22, 24. Posting can be accomplished by submitting the application via email, posting the application on the third-party sites 22, 24, uploading the application to the third-party sites 22, 24, and providing a download link on the third-party sites 22, 24.

At step 124, primary online service 20 assigns an identification code to the end user; an example of the unique identification code can be user id, password, or other methods of identification. The unique identification code is then stored in a user profile database 66 and can be access by the points transaction site 56; the unique identification code can also be stored on any storage medium to which the primary online service 20 has access.

At step 126, there occurs an associating of an application identification value 82 of at least one applications 48, 50 with at least one third-party sites 22, 24. For example application 48 can be associated with the third-party site 22. Application 50 can be associated with the third-party service 24. The application 50 can be a part of the application 48; the application 48 can be a part of the application 50; the application 48 and the application 50 can be part of another application so that a single combined application can associate with more than one third party service site. At step 128, the user retrieves the already associated application 48, 50 at the third-party sites 22, 24. Retrieving the already associated application 48, 50 can typically be done by having the user add the application via the add application function that's provided by the third-party sites 22, 24. At step 130, the user links back to the primary online service 20 through the login module 84 of the application 48, 50 with the unique identification code the user used to register at the third-party sites 22, 24.

Referring to FIGS. 1 and 2, the method of awarding points includes registering with primary online service 20 with an USER ID and a PASSWORD so that the user is uniquely identifiable within a user profile database 66 and a incentive point account 64; associating an unused widget with an unique application identification value with at least one third-party sites 22, 24, for example Face Book or MySpace; retrieving the associated widget at the at least one third-party sites 22, 24 via the ‘add widget’ mechanism, wherein the ‘add widget’ mechanism is typically provided by the at least one third-party Web 2.0; linking the user from the at least one third-party sites 22, 24 back to primary online service 20 via the login module of the widget using the user id and password registered at the points transaction server; and selectively awarding points for activities of the user at the at least one third-party sites 22, 24, wherein primary online service 20 and the widget award points to the user based on a at least one point awards rule.

As shown in FIG. 1 an aspect of the primary online service 20 is the points transaction unit 58. The points transaction unit 58 enables the user to exchange the points collected with points of other users; to exchange points collected for cash, goods, services; to donate points collected to charity; and to provide function for points marketplace. The goods can include redeemable item, or any other tangible goods. The points transaction unit 58 S.1, the points transaction unit 58 is configured to connect with the transaction database 70 and the item database 72; the points transaction unit 58 is further configured to connect with the user profile database 66 and the incentive point account 64 via the points transaction site 56.

When the user has been awarded at least one point, the user has the ability to make an offer to buy or sell a fixed number of points at a price per point through the point transaction unit. When the user wants to make an offer to buy or sell a fixed number of points at a price per point, and in response to that offer, another user can “Take It”, which means that the user is willing to pay the asking price per point; the another user can also make an counter offer for a different price pint, for example counter offer at a price lower than the “Take It” price. When another user makes a counter offer with respect to the user's offer, the counter offer can be accepted or rejected by the user. If a “Take It” or counter offer fails, the points transaction unit 58 may suggest alternative offers in the marketplace to provide the another user an option to try again. If a “Take It” or counter is successful, the transaction should close and the points should be transferred with the payment processing solution, for example using credit card or PayPal. The user has the ability to cancel the posted offer at any time unless the transaction has been completed either in full or in part.

The user also has the ability to adjust the parameters of the offer at any time, but cannot adjust the parameters of already completed or partially completed transaction. To handle a race condition of multiple “Take It” request arriving at the same time, the points transaction unit 58 will attempt to fill the order on a first-come-first-served basis. However, if the another user requires less points than what's offered, the remaining points can be allocated to the user next in line after the another user, until the total points in the offer is exhausted. However, if the another user require more points than what's offered, the another user can selectively elect to partial fill the point, which means to take as many points as offer. Persons of ordinary skill in the art will readily appreciate the technique of handle points trading and the race condition previously disclosed can be accomplished with other compatible schemes or techniques.

The points transaction unit 58 may from time to time offer items from the item database 72 so that the user can redeem the points stored in the incentive point account 64 for those items. The items stored in the item database 72 will usually include a description, a photo, an optional limit per user of the number of times the item can be redeemed, an optional total number of redemptions across the entire marketplace, an optional expiration date, and the minimum points need for redemption. The item database 72 can only be modified by the points transaction site 56 proprietor or it agent.

As shown in FIG. 1 the points transaction unit 58 is operably connected to the transaction database 70, wherein the transaction database 70 is configured to store transaction details, for example the USER IDs of the users, the points exchanged, the timestamp of the transaction, and etc. The points transaction unit 58 can use the data stored in the transaction database 70 to produce volume and statistic to indicate activity, for example the statistics may say that 124,000 points and $3,240 were transacted within the past 24 hours on the points transaction site 56. The statistics can also be communicated to the widget through the application communication unit 60 and accepted by the widget through the transaction site communication module 82.

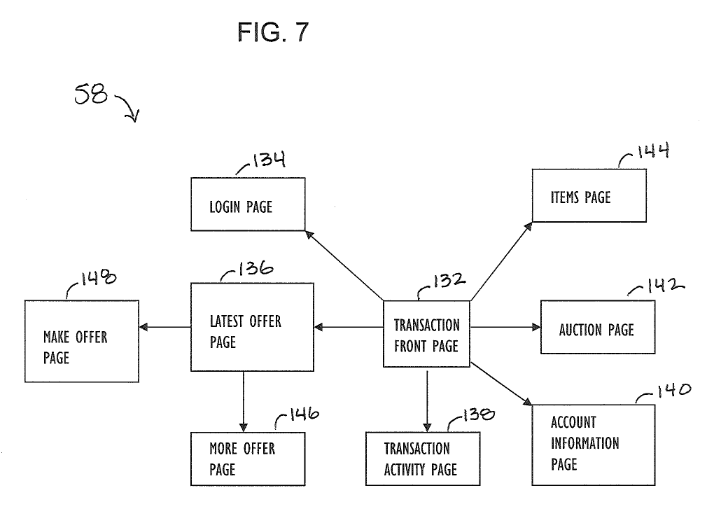

As shown in FIGS. 1 and 7 the points transaction unit 58 includes a transaction font page 132, a login page 134, a latest offer page 136, a transaction activity page 138, an account information page 140, an auction page 142, and a items page 144. The latest offer page 136 further includes a more offer page 146 and a make offer page 148. From the transaction front page 132 the user can access the login page 134. When the user is not logged in, the login page will typically show login or signup link and language; when the user is already logged in, the login page can displays a mini dashboard with the user's latest points transactions through the points transaction unit. The dashboard can show other statics, for example the user's current points balance, logout link, and account link.

From the marketplace front page the user can also access the latest offer page 136. The latest offer page 136 can display the latest and most opportune offers either by highest buying price or the lowest selling price. The latest offer page 136 can also display a listing of the latest offers including the user id of the offeror, the number of points offered, the asking price for the points offered, the date of the offer, and a brief message regarding the offer. The user can further access additional offers by accessing the more offer page from the latest offer page. When the user wishes to make an offer, the user can access the make offer page 148 from the latest offer page 136. The make offer page 148 can display the user posting the offer, their quoted amount, the list of rejected or open counter. The make offer page 148 also has the option to let the user “Take It” or counter the offer.

From the transaction front page 132 the user can also access the item page 144. The item page 144 lists the items that the user can use points to redeem. The items can include electronics, for example iPod, other products, or any other tangible items. From the transaction front page 132 the user can also access the transaction activity page 138. The information presented in the transaction activity page 13 8 are gathered from the transaction database 70 and can display the present latest action, the present daily action, trade numbers and values, current market value on points, and etc.

The user can also access the account information page 140 from the transaction front page 132. The account information page 140 can gather information stored on the incentive point account 64, user profile database 66, transaction database 70, item database 72 or a combination of one or more databases. The user account information page can be configured to display any information related the user. The user can also sell the incentive points by auction via the auction page 142. The auction page can also be configured to conducting an auction of goods through the points transaction unit 58 of the primary online service 20, and permit users to bid for goods at the auction using points.

One example of marketplace transaction through the points transaction unit 58 involves if user A offer X points for $Y each for sale at a fixed price, and user A provides a linked account to receive payment, for example a PayPal account, the offer to sale appears in the marketplace and on the front page as what the points are selling for. User B will then agrees to purchase Z points, so that X points is deducted from user A's incentive points account while X points is added to user B's incentive points account. If Z is great than X, the transaction clearly immediately and the user B should be directed to the pay user A for the points via one of the predetermined payment options. The points transaction unit 58 will then deduct a predetermined amount of marketplace fee from the payment made by user B. If X is less than Z, then user A's offer stays in the marketplace, but for X-Z points.

Another example of marketplace transaction through the points transaction unit 58 involves when user A wants X points and is willing to pay $Y for each. User A posts an offer in the marketplace and the offer appears in the marketplace and on the front page as an offer to buy. User A provides a method of payment, for example PayPal, or other linked payment method to guarantee the amount for each point. User B has some Z points and wants to sell; user B selects the offer from user A in the marketplace. User B is then provided with a link to PayPal or another account to receive payment. User B's Z points are then held until user A confirms payment, and user A transfers Z points to user B upon receipt of the payment of user B, wherein user A's incentive points account 64 is increased by Z points while user B's incentive points account 64 is decreased by Z points.

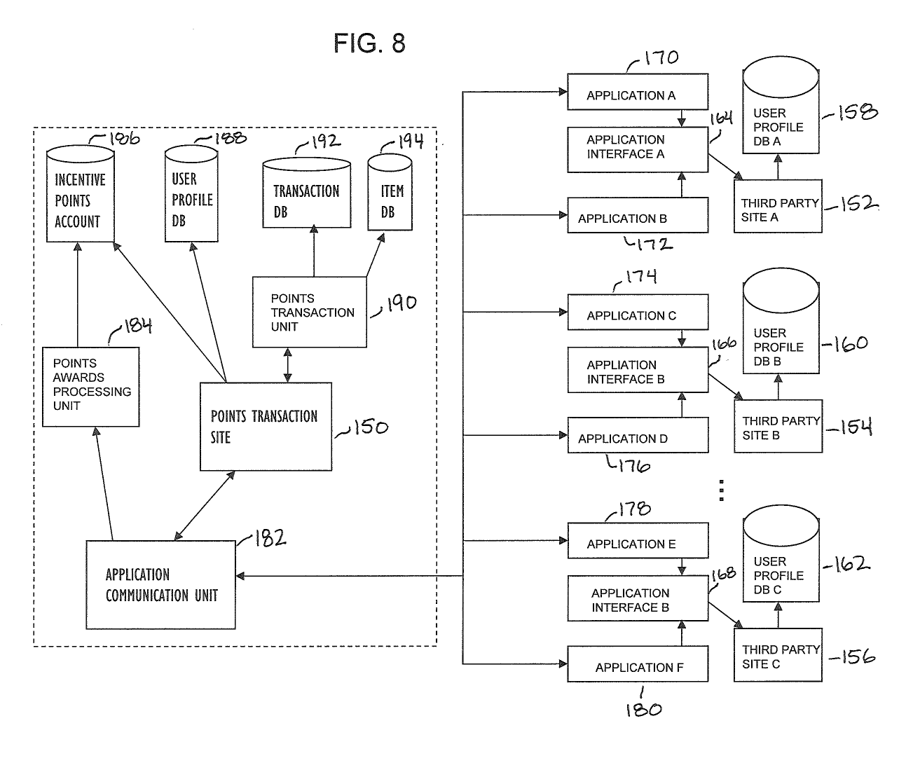

FIG. 8 is a block diagram showing the point awards system according to another embodiment. The point awards system includes a points transaction server 150, and at least one third party online site 152-156. Each third party online site 152-156 further includes a user profile database 160-162; at least one application interface 164-168; and at least one application 170-180. The points transaction server 150 includes an application communication unit 182, a points award processing unit 184, a incentive point account 186, a user profile database 188, and a points transaction unit 190. The points transaction unit 190 further includes a transaction database 192, and an item database 194.

An application is typically embedded in the third party online site as a section of third party online site code; and the application can normally access the third party online site via the application interface 164-168. The application interface is usually provided by the third party online site server, an example of application interface is Facebook API or Open Social API.

As shown in FIG. 8, the points transaction server 150 has access to an incentive points account 186 and a user profile database 188; the points award processing unit 184 has access to the incentive points account 186; and the points transaction unit 190 has access to a transaction database 192, and an item database 194. The application communication unit 182 is further connected to application A 170, application B 172, application C 174, application D 176, application E 178, and application F 180. The number of application the application communication unit 182 can connect to is not limited to the six application shown in FIG. 8.

The user can deploy more than one application A 170 more than one third party online site 152-156 by perform the following steps. First, the user registers with the points transaction server 150 with a unique identification code. The unique identification code is then stored in the user profile database 188 and can be access by the points transaction site 190. Next, the user associates an unused application with a unique application identification value with one third party online site. For example, the user can associate application A 170 with third-party site A 152. The user then can associate another unused application with a unique application identification value with another third party online site.

For example, the user can associate application C 174 with third-party site B 154 or the user can associate application E 178 with third-party site C 156. After the user finishes associating the application to their respective third party online sites, the user can retrieve the already associated application at their respectively associated third party online sites. For example, the user can retrieve application A 170 at the third-party site A 152 using the “add application” function typically provided at the third party online site; the user can retrieve application C 174 at the third-party site B 154; the user can retrieve application E 178 at the third-party site C 156. The user then can link the different application now embedded in each of the third-party site B 154 ack to the points transaction server 150 with the unique identification code user used to register at the points transaction server 150.

For example, the user can link application A 170 residing on the third-party site A 152 back to The points transaction server 150 by using the user id and password stored in the user profile database 188 on the points transaction server 150 when the user first registered with the points transaction server 150; the user can link application C 174 residing on the third-party site B 154 back to the points transaction server 150 by using the same user id and password stored in the user profile database 188 on the points transaction server 150 when the user first registered with the points transaction server 150; the user can link application E 178 residing on the third-party site C 156 back to the points transaction server 150 by using the same user id and password stored in the user profile database 188 on the points transaction server 150 when the user first registered with the points transaction server 150.

The application A 170 residing on the third-party site A 152 has the ability to query application C 174 or application E 178 residing on third-party site B 154 and third-party site C 156 respectively. Referring to FIGS. 2 and 8, this can be accomplished by having application A 170 access the incentive point account 186, the user profile database 188 and the transaction database 192 residing on the points transaction server 150 through the transaction site communication module 82, and the application communication unit 182. Since application A 170, application C 174, and application E 178 can all access the same databases with the same user id and password, application A 170, application C 174 and application E 178 can effectively communicate with each other through the points transaction server 150.

Referring to FIG. 8, it is also possible to have application A 170 of user A access application B 172 of user B or to have application A 170 of user A access application D 176 and application F 180 of user C. This can be accomplished by the following steps. First, user A registers with The points transaction server 150 with a unique identification code; user B registers with The points transaction server 150 with a unique identification code; and user C registers with The points transaction server 150 with a unique identification code. The unique user ids and passwords of user A, user B, and user C is separately stored in the user profile database 66 and can be points transaction server.

Next, user A associates unused application A 170 with a unique application identification value with third-party site A 152; user B associates unused application B 172 with an unique application identification value with third-party site A 152; and user C associates unused application D 176 with an unique application identification value with third-party site B 154, and associates unused application F 180 with an unique application identification value with third-party site C 156. After the users finish associating the application to their respective third party online sites, user A can retrieve the already associated application A 170 at the third-party site A 152; user B can retrieve the already associated application B 172 at the third-party site A 152; and user C can retrieve the already associated application D 176 at the third-party site B 154 and application F 180 at the third-party site C 156. Retrieving the application can be accomplished by ‘add application’ function that's typically provided by the third party online sites.

Nest users can link the different application now embedded in the third party online sites back to the points transaction server 150. User A can link application A 170 residing on the third-party site A 152 back to the points transaction server 150 by using the user A's user id and password stored in the user profile database 188; user B can link application B 172 residing on the third-party site A 152 back to the points transaction server 150 by using the user B's user id and password stored in the user profile database 188; and user C can link application D 176 residing on the third-party site B 154 back to the points transaction server 150 by using user C's user id and password stored in the user profile database 188 and link application F 180 residing on the third-party site C 156 back to the points transaction server 150 by using user C's user id and password stored in the user profile database 188.

If user A has access to user B or user C's application, for example if user B and user C is on user A's friends list, user A can use application A 170 residing on the third-party site A 152 to access application B 172 of user B residing on third-party site B 154, application D 176 of user C residing on third-party site B 154, and application F 180 of user C residing on third-party site C 156. Referring to FIG. 2 and 8, this can be accomplished by having application A 170 access the user A's friend list stored in the user profile database 188 and if user B and user C is on the user A's friend list, user A can use application A 170 to communicate with application B 172 of user B, application D 176, and application F 180 of user C by accessing the user profile database 188 of user B and user C through the transaction site communication module 82, and the points transaction server 150.

Alternatively, user A can user application A 170 to query the third-party site A 152 through the application interface A 164 for a list of user A's friends with application already embedded with the third-party site A 152, for example if user B is user A's friend and user B has already embedded application B 172 with third-party site A 152, user A can use application A 170 to communicate with application B 172 of user B. This can be accomplished by using application A 170 to access the user profile database 188 of user B residing on the user profile database 188 of points transaction server 150 through the transaction site communication module 82, and the application communication unit 182.

The above-described embodiments have been described in order to allow easy understanding of the invention and do not limit the invention. On the contrary, the invention is intended to cover various modifications and equivalent arrangements included within the scope of the appended claims, which scope is to be accorded the broadest interpretation so as to encompass all such modifications and equivalent structure as is permitted under the law.

What is claimed:

1. A method for permitting a primary online service to award incentive points to users of a third-party site that operates independently of the primary online service, comprising:
publishing copies of a computer program on the third-party site, the computer program including instructions that cause one or more computers to:
collect usage information concerning the activities performed on the third-party site by users who add the computer program to their user accounts on the third-party site; and
transmit the usage information to the primary online service;
awarding incentive points to the users based on the usage information received by the primary online service; and
redeeming incentive points for consideration;
wherein the awarding of incentive points by the primary online service is substantially independent of the operation of the third-party site.

2. The method of claim 1, further comprising:
transmitting an identification code to at least one of the users, wherein the computer program is further programmed to store the identification code of that user.

3. The method of claim 2, further comprising:
maintaining an incentive point account for the at least one user to track the balance of the at least one user's incentive points, the account associated with the user's identification code.

4. The method of claim 3, further comprising:
displaying the balance of the at least one user's incentive point account when the user accesses the third-party site.

5. The method of claim 3, further comprising:
permitting the at least one user to designate one or more other users as friends;
displaying the balance of the incentive point account of the at least one user to the friends.

6. The method of claim 1, further comprising:
displaying advertising information to at least one user while the computer program collects usage information concerning the activities performed by that user on the third-party site.

7. The method of claim 1, further comprising:
permitting at least one user to buy and sell incentive points through the primary online service.

8. The method of claim 7, wherein the at least one user is permitted to buy incentive points from at least one other user and to sell incentive points to at least one other user, through the primary online service.

9. The method of claim 1, wherein each user is permitted to sell incentive points by auction.

10. The method of claim 1, wherein the consideration is at least one of cash, goods, services, software, content and contributions to a charity.

11. The method of claim 1, further comprising:
conducting an auction of goods through the primary online service and permitting a plurality of users to bid for goods at the auction using points.

12. The method of claim 1, further comprising:
awarding incentive points to users who distribute the computer program to other users of the third-party site.

13. The method of claim 1, wherein the computer program is programmed to communicate with the third-party site through an API published by the operators of the third-party site.

14. A method for permitting a primary online service to award incentive points to users of a plurality of independently operated third-party sites, comprising:
distributing a computer program on each of the plurality third-party sites, the computer program including instructions that cause at least one computer to:
collect usage information concerning the activities performed on that third-party site by users who activate the computer program for use with their user accounts on that third-party site;
associate an identification code for each user who activates the computer program, the code being assigned by the primary online service;
transmit the usage information for each user and the user's identification code to the primary online service;
awarding points to each user based the usage information associated with that user's identification code, and tracking points awarded in an incentive point account associated with the user;
providing a facility through the primary online service to permit users to exchange points for consideration; and
displaying the balance of the at least one of user's incentive point account when the user accesses at least one of the social networks through a user account for which the user has activated the computer program.

15. The method of claim 14, wherein displaying the balance of the at least one user's associated incentive point account further comprises:
displaying to the user advertising messages originating from primary online service.

16. The method of claim 15, wherein
the usage information pertaining to the at least one user includes only activities performed by the at least one user while the advertising messages were displayed to the at least one user.

17. The method of claim 14, further comprising:
providing a facility through the primary online service to permit the users to buy and sell incentive points.

18. The method of claim 14, wherein the consideration is at least one of goods, services, software, content and contributions to a charity.

19. The method of claim 14, further comprising:
awarding incentive points to users who distribute the computer program to other users.

20. The method of claim 14, further comprising:
permitting at least a first user to designate one or more other users as friends;
displaying to the friends the first user's incentive point account balance.

21. The method of claim 14, wherein the third-party sites include at least one of a social networking site, online auction site, online forum, and online store.

22. The method of claim 14, further comprising:
permitting at least a first one of the users to designate one or more other users as friends; and
displaying to at least one of the friends information about the first user's activities at a first third-party site while the friend accesses a different third-party site.

23. A method for permitting a primary online service to award incentive points to users of a third-party site that operates independently of the primary online service, comprising:
collecting usage information concerning the activities performed on the third-party site by users who opt to receive the incentive points;
transmitting the usage information to the primary online service;
awarding incentive points to the users based on the usage information, wherein the awarding of incentive points by the primary online service is substantially independent of the operation of the third-party site;
displaying to at least one of the users an advertising message originating from the primary online service when the at least one user is conducting activities on the third party web site;
providing a facility on the primary online service to permit the at least one user to buy and sell incentive points to and from at least one other user; and
redeeming the incentive points for consideration.

24. The method of claim 23, wherein the consideration is redeemable in limited quantities on a first-come-first-served basis.

25. The method of claim 23, wherein the consideration is redeemable for a limited time period.

26. The method of claim 23, wherein the consideration is redeemable for a number of incentive points that is set by an auction among users seeking the consideration.

27. The method of claim 23, wherein the consideration is a chance to receive at least one of a good, service, software and content.

28. The method of claim 23, wherein the incentive points are redeemable for only a limited time period.

29. The method of claim 23, wherein the at least one user is permitted to buy and sell incentive points at auction.

30. The method of claim 23, further comprising:
permitting the at least one user to designate other users as friends;
displaying to the friends the number of points awarded t the at least one user.
